(19) United States
(12) Patent Application Publication
(10) Pub. No.: US 2022/0082264 A1
(43) Pub. Date: Mar. 17, 2022

(54) VEHICLE TAILGATE BBQ GRILL

(71) Applicant: GrillGate LLC, Sheridan, WY (US)

(72) Inventor: Tyler O'Daniel, Sheridan, WY (US)

(73) Assignee: GrillGate LLC, Sheridan, WY (US)

(21) Appl. No.: 17/473,422

(22) Filed: Sep. 13, 2021

Related U.S. Application Data
(60) Provisional application No. 63/079,716, filed on Sep. 17, 2020.

(51) Int. Cl. F24C 3/14; B62D 33/03; B60N 3/16; F24C 15/14; A47J 37/07; A47J 36/36

(52) U.S. Cl. CPC F24C 3/14; B62D 33/03; B60N 3/16; F24C 15/14; E05B 83/00; A47J 37/0713; A47J 37/0786; A47J 36/36; A47J 37/0709

(57) ABSTRACT

The present disclosure is directed to a novel apparatus, method, and system for a vehicle tailgate BBQ grill system. The vehicle tailgate BBQ grill system has a grease tray integrated into the tailgate configured to capture grease and prevent grease from leaking into the tailgate. A dust cover fits over the grill system preventing debris from entering the vehicle tailgate BBQ grill system while the vehicle is in motion. A cover at a top of the tailgate has a closed position configured to hide the control knobs.

### PRIORITY STATEMENT

This application claims priority to U.S. Provisional Patent Application No. 63/079,716 filed on Sep. 17, 2020, titled VEHICLE TAILGATE BBQ GRILL, all of which are hereby incorporated by reference in their entireties.

### FIELD OF THE DISCLOSURE

The present disclosure relates to grilling. More particularly, but not exclusively, the present disclosure relates to a vehicle tailgate BBQ grill.

### BACKGROUND

Trucks or other vehicles often have a drop-down tailgate that provides access to a cargo area, such as a bed for storage. Most tailgates have a closed position where the tailgate is latched to the sides of the vehicle, locking it in place. When the latch is released, the tailgate is lowered to a generally horizontal position to allow access to the bed and the tailgate. However, tailgates provide only limited functionality. The tailgate may provide a stepping point for ingress and egress into and out of the bed or other cargo area or support for objects extending beyond the cargo area. While camping, picnicking, hunting, or attending tailgating events, a grill is often hauled in the cargo area for use at other locations and venues. The grill may spill grease onto the bed of the vehicle, cargo area, or over other objects being transported with the grill. If used in the vehicle, heat from the grill may cause damage to the cargo area or objects being transported close to the grill.

Therefore, what is needed is a vehicle tailgate BBQ grill that is operably integrated into the tailgate of a vehicle that incorporates a heat shield lining that redirects heat away from the vehicle, a grease collection system to keep grease from collecting in the vehicle tailgate, and one or more detachable parts that facilitate easier cleaning, use, assembly, disassembly, changing out the fuel source, and overall operation of the vehicle tailgate BBQ grill.

### SUMMARY

Therefore, it is a primary object, feature, or advantage of the present disclosure to improve over the state of the art.

It is a further object, feature, or advantage of the present disclosure to provide a safer way of transporting a grill.

It is a still further object, feature, or advantage of the present disclosure to a cleaner way of transporting a grill.

Another object, feature, or advantage is to provide an efficient way to drain the grease out of the grease pan integrated into the tailgate.

Yet another object, feature, or advantage is to provide access to the grilling knobs while the tailgate is in an open position and a closed position.

In one aspect of the present disclosure, a vehicle tailgate BBQ grill system is disclosed. The vehicle tailgate BBQ grill system includes, in at least one aspect, a tailgate configured to operably house the vehicle tailgate BBQ grill system, a grease tray integrated into the tailgate configured to funnel grease out of the tailgate, a grate that is supported by the grease tray where the grate is configured to drop grease and debris into the grease tray, a plurality of heat plates, a plurality of flame elements, at least one storage compartment where the storage compartment is configured to hold a fuel container wherein the fuel container is operably connected to the plurality of flame elements, at least one control knob operably connected to the fuel container and the plurality of flame elements, a cover at a top of the tailgate having a closed position configured to hide the control knobs wherein the cover has an open position configured to reveal the control knobs, a grill cover, a bottom of the grease tray is angled to allow grease to drain through a hole in the bottom of the grease tray, and wherein a grease container is coupled to the grease tray to collect grease when the tailgate is in an open horizontal position.

In another aspect of the present disclosure, a vehicle tailgate BBQ grill system is disclosed. The vehicle tailgate BBQ grill system includes, in at least one aspect, a tailgate with a front end and a back end and operably configured to house the vehicle tailgate BBQ grill system having a grease tray integrated into the tailgate configured to funnel grease out of the tailgate, a grate that is supported by the grease tray and configured to drop grease and debris into the grease tray, a first storage compartment configured to hold a fuel container, at least one control knob operably connected to the fuel container, a cover at a top of the tailgate having a closed position configured to hide the control knobs and an open position configured to reveal the control knobs, a first portion of the cover is rotatably connected to the second portion, a grill cover, a bottom of the grease tray is angled to allow grease to drain through a hole in the bottom of the grease tray, a tailgate hole on the back end of the tailgate configured to receive the grease container, and a decal on the back end of the tailgate.

In yet another aspect of the present disclosure, a vehicle tailgate BBQ grill system is disclosed. The vehicle tailgate BBQ grill system includes a tailgate operably housing the vehicle tailgate BBQ grill system. The tailgate has a proximal end rotatably connect to a vehicle bed opposing a distal end, a front end opposing a back end, a first side opposing a second side, and an open position wherein the front end of the tailgate is flush with the vehicle bed. The vehicle tailgate BBQ grill includes, in at least one aspect, a grease tray integrated into the tailgate configured to funnel grease out of a tailgate hole on the back end of the tailgate, a grate operably supported by the grease tray and operably configured to drop grease and debris into the grease tray, at least one storage compartment on the first side of the tailgate configured to hold a fuel container that is operably connected to the plurality a flame elements configured to heat the grate and objects/food atop the grate, a plurality of control knobs operably connected to the fuel container and the plurality of flame elements, a cover at the distal end of the tailgate having a closed position configured to hide the plurality of control knobs and an open position configured to reveal the plurality control knobs, a grill cover, a bottom of the grease tray is operably angled to allow grease to drain through a drainage hole in the bottom of the grease tray, and a grease container is removably coupled to the grease tray to collect grease when the tailgate is in the open position.

In yet another aspect of the present disclosure, a vehicle tailgate BBQ grill system is disclosed. The vehicle tailgate BBQ grill system includes a tailgate configured to hold the vehicle tailgate BBQ grill system, wherein the tailgate is configured to attach to a vehicle bed and comprises a front end opposing a back end and a first end opposing a second end. The vehicle tailgate BBQ grill system may also include a grease tray integrated into the tailgate configured to collect grease and a grate, wherein the grate is supported by the grease tray; the grate is configured to drop grease and debris into the grease tray. The vehicle tailgate BBQ grill system includes a plurality of heat spreaders, at least one flame element. and at least one storage compartment, the storage compartment configured to hold a fuel container. The fuel container is operably connected to the plurality of flame elements. The vehicle tailgate BBQ system has at least one control knob operably connected to the fuel container and the at least one flame element and a vehicle tailgate BBQ grill cover disposed on the front end of the tailgate. The vehicle tailgate BBQ grill cover has an open position configured to reveal the grate, and the vehicle tailgate BBQ grill cover has a first part rotatably connected to the tailgate.

In another aspect of the present disclosure another vehicle tailgate BBQ grill system is disclosed. The vehicle tailgate BBQ grill system includes a tailgate configured to hold the vehicle tailgate BBQ grill system. The tailgate has a front end opposing a back end and a top portion opposing a bottom portion. The bottom portion is configured to be attached to a vehicle. The vehicle tailgate BBQ grill system further includes a cooking unit disposed within the front end of the tailgate configured to heat a grate. The cooking unit includes a grease tray operably integrated into the tailgate, a grate operably supported by the grease tray. The grate is configured to drop grease and debris into the grease tray. The cooking unit also includes a vehicle tailgate BBQ grill cover having a closed position configured to hide the grate and an open position configured to reveal the grate. A first part of the vehicle tailgate BBQ grill cover is rotatably connected to the front end of the tailgate. The cooking unit may further include a heat shield configured to protect the back end of the tailgate from cooking unit. The vehicle tailgate BBQ grill system may also include a first storage compartment on a first side of the grate and at least one control knob operably connected a fuel source and at least one fuel element. The fuel source powers the at least one flame element. The at least one control knob is covered when the tailgate is in a closed position. Lastly, the vehicle tailgate BBQ grill system may also include a dust cover configured to prevent debris from entering the cooking unit when the vehicle tailgate BBQ grill cover is in the closed positioned.

In yet another aspect of the disclosure, another vehicle tailgate BBQ grill system is disclosed. The vehicle tailgate BBQ grill system includes a tailgate configured to hold the vehicle tailgate BBQ grill system. the tailgate has a proximal end rotatably connect to a vehicle bed opposing a distal end, a front end opposing a back end, a first side opposing a second side, and an open position wherein the front end of the tailgate is flush with the vehicle bed. A vehicle tailgate BBQ grill is integrated into the front end of the tailgate. The vehicle tailgate BBQ grill includes a grease tray integrated into the tailgate configured to capture grease and debris and a grate operably supported by the grease tray and operably configured to drop grease and debris into the grease tray. The vehicle tailgate BBQ grill includes a first storage compartment on a first side of the grate, the storage compartment configured to hold a fuel container. The fuel container is operably connected to a plurality of flame elements configured to heat the grate. The vehicle tailgate BBQ grill also includes a second storage compartment on the second side of the grate. The storage compartment is countersunk from a surface of the front end of the tailgate. The vehicle tailgate BBQ grill system further includes a plurality of control knobs operably connected to the fuel container and the plurality of flame elements and a grill cover at the proximal end of the tailgate having a closed position configured to hide the grate. The grill cover has an open position configured to reveal the grate. Lastly the vehicle tailgate grill includes a lift assist.

One or more of these and/or other objects, features, or advantages of the present disclosure will become apparent from the specification and claims that follow. No single embodiment need provide each and every object, feature, or advantage. Different embodiments may have different objects, features, or advantages. Therefore, the present disclosure is not to be limited to or by any objects, features, or advantages stated herein.

### BRIEF DESCRIPTION OF THE DRAWINGS

Illustrated aspects of the disclosure are described in detail below with reference to the attached drawing figures, which are incorporated by reference herein.

FIG. 1 is an illustration of the of the vehicle tailgate BBQ grill system;

FIG. 2 is an illustration of the tailgate in the closed position;

FIG. 3 is a perspective view of the vehicle tailgate BBQ grill system

FIG. 4 is a side view of the vehicle tailgate BBQ grill system;

FIG. 5 is a back view of the vehicle tailgate BBQ grill system;

FIG. 6 is a perspective view of the vehicle tailgate BBQ grill system in the open position;

FIG. 7 is a front view of the vehicle tailgate;

FIG. 8 is an additional view of the tailgate grilling system in the open position;

FIG. 9 is an exploded view of the tailgate grilling system;

FIG. 10 is a view of the cover of the tailgate grilling system in the open position;

FIG. 11 is a top view of the cover of the tailgate grilling system in the closed position;

FIG. 12 is a perspective view of the grease tray;

FIG. 13 is a top view of the grease tray;

FIG. 14 is a perspective view of the bottom of the grease tray;

FIG. 15A is a view of the back of the tailgate;

FIG. 15B is another view of the back of the tailgate;

FIG. 15C is an additional view of the back of the tailgate;

FIG. 16 is another view of the vehicle tailgate BBQ grill system;

FIG. 17 is a perspective view of the back end of the tailgate;

FIG. 18 is a top view of the front end of the tailgate; and

FIG. 19 is a perspective view of the vehicle tailgate BBQ grill system.

### DETAILED DESCRIPTION

The present disclosure is directed to an apparatus, method, and system for a vehicle tailgate BBQ grill system having, in at least one aspect, a grill operably integrated into a vehicle tailgate. The present disclosure finds applicability to the safe and cleaner transportation of a grill to a desired location such as to a campsite, tailgating event, or other destinations, venues, places, and events. A user of the vehicle tailgate BBQ grill can lower the tailgate and begin cooking on the grill without having to unload and set up the vehicle tailgate BBQ grill. The grease drainage configuration, plumbing, and outlet allow for draining of the grease or any other cooking remnants allowing for a fast and effective cleaning of the vehicle tailgate BBQ grill.

In one aspect of the present disclosure, a vehicle tailgate BBQ grill system is disclosed. The vehicle tailgate BBQ grill system includes, in at least one aspect, a tailgate configured to operably house the vehicle tailgate BBQ grill system, a grease tray integrated into the tailgate configured to funnel grease out of the tailgate, a grate that is supported by the grease tray where the grate is configured to drop grease and debris into the grease tray, a plurality of heat plates, a plurality of flame elements, at least one storage compartment where the storage compartment is configured to hold a fuel container wherein the fuel container is operably connected to the plurality of flame elements, at least one control knob operably connected to the fuel container and the plurality of flame elements, a cover at a top of the tailgate having a closed position configured to hide the control knobs wherein the cover has an open position configured to reveal the control knobs, a grill cover, a bottom of the grease tray is angled to allow grease to drain through a hole in the bottom of the grease tray, and wherein a grease container is coupled to the grease tray to collect grease when the tailgate is in an open horizontal position.

In another aspect of the present disclosure, a vehicle tailgate BBQ grill system is disclosed. The vehicle tailgate BBQ grill system includes, in at least one aspect, a tailgate with a front end and a back end and operably configured to house the vehicle tailgate BBQ grill system having a grease tray integrated into the tailgate configured to funnel grease out of the tailgate, a grate that is supported by the grease tray and configured to drop grease and debris into the grease tray, a first storage compartment configured to hold a fuel container, at least one control knob operably connected to the fuel container, a cover at a top of the tailgate having a closed position configured to hide the control knobs and an open position configured to reveal the control knobs, a first portion of the cover is rotatably connected to the second portion, a grill cover, a bottom of the grease tray is angled to allow grease to drain through a hole in the bottom of the grease tray, a tailgate hole on the back end of the tailgate configured to receive the grease container, and a decal on the back end of the tailgate.

In yet another aspect of the present disclosure, a vehicle tailgate BBQ grill system is disclosed. The vehicle tailgate BBQ grill system includes a tailgate operably housing the vehicle tailgate BBQ grill system. The tailgate has a proximal end rotatably connect to a vehicle bed opposing a distal end, a front end opposing a back end, a first side opposing a second side, and an open position wherein the front end of the tailgate is flush with the vehicle bed. The vehicle tailgate BBQ grill includes, in at least one aspect, a grease tray integrated into the tailgate configured to funnel grease out of a tailgate hole on the back end of the tailgate, a grate operably supported by the grease tray and operably configured to drop grease and debris into the grease tray, at least one storage compartment on the first side of the tailgate configured to hold a fuel container that is operably connected to the plurality a flame elements configured to heat the grate and objects/food atop the grate, a plurality of control knobs operably connected to the fuel container and the plurality of flame elements, a cover at the distal end of the tailgate having a closed position configured to hide the plurality of control knobs and an open position configured to reveal the plurality control knobs, a grill cover, a bottom of the grease tray is operably angled to allow grease to drain through a drainage hole in the bottom of the grease tray, and a grease container is removably coupled to the grease tray to collect grease when the tailgate is in the open position.

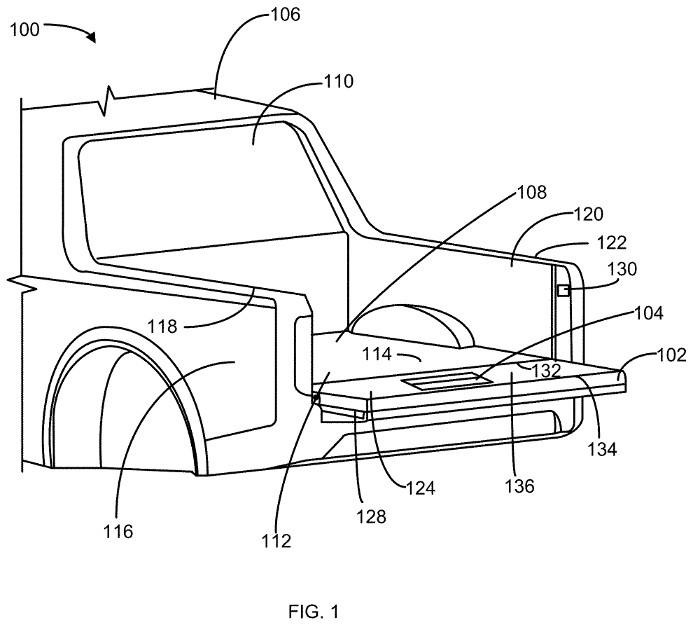

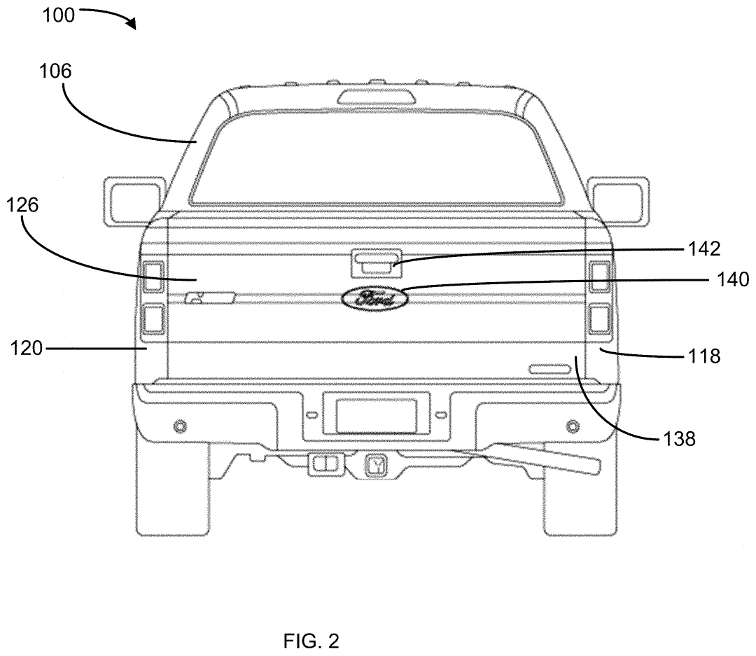

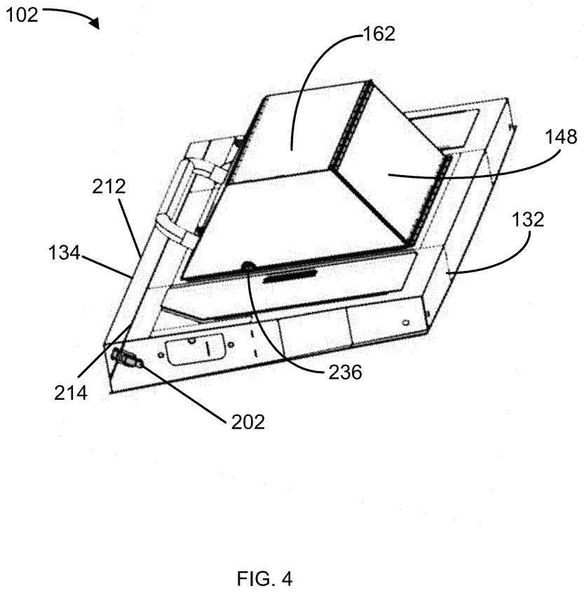

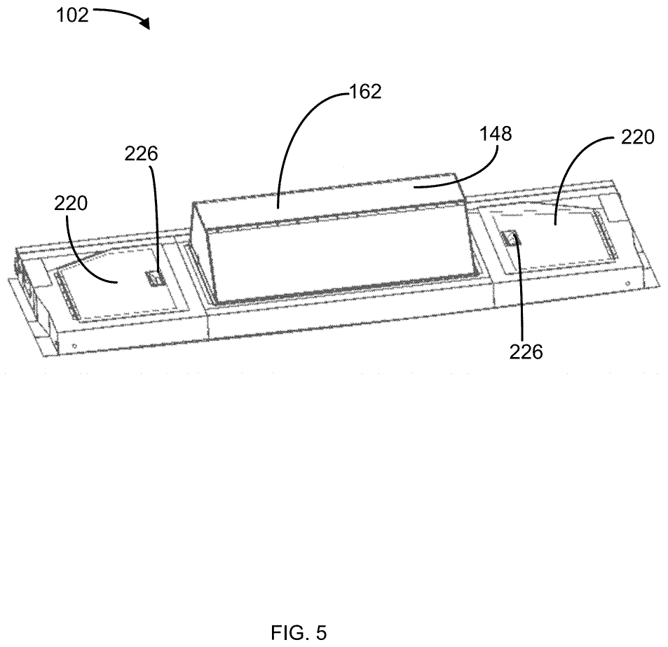

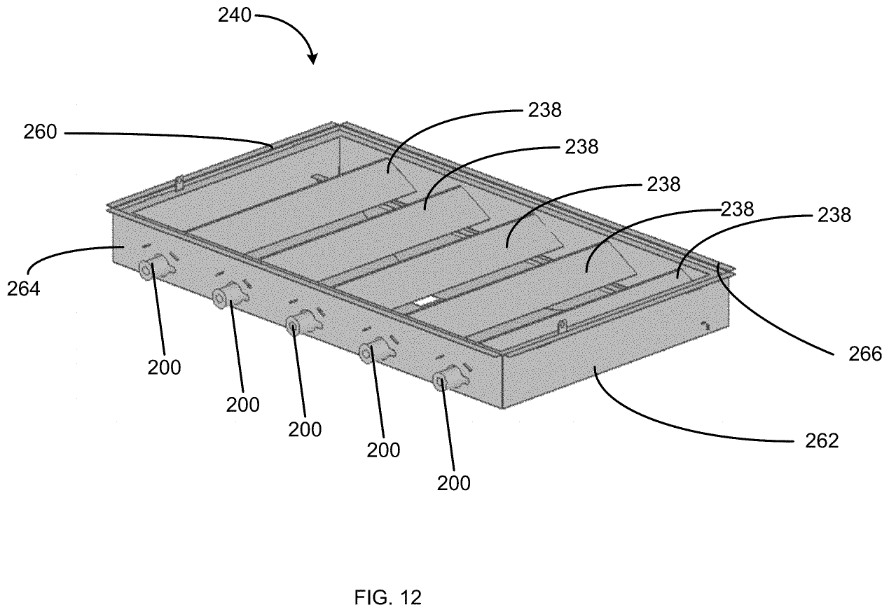

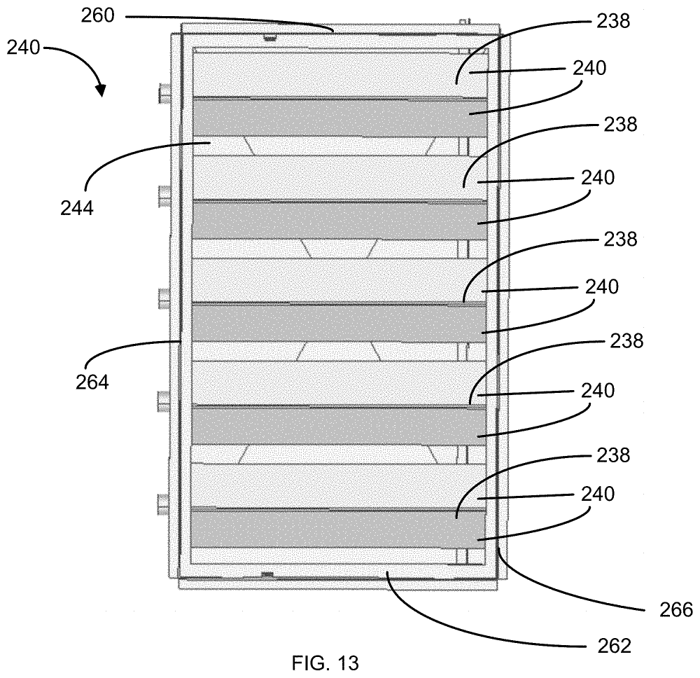

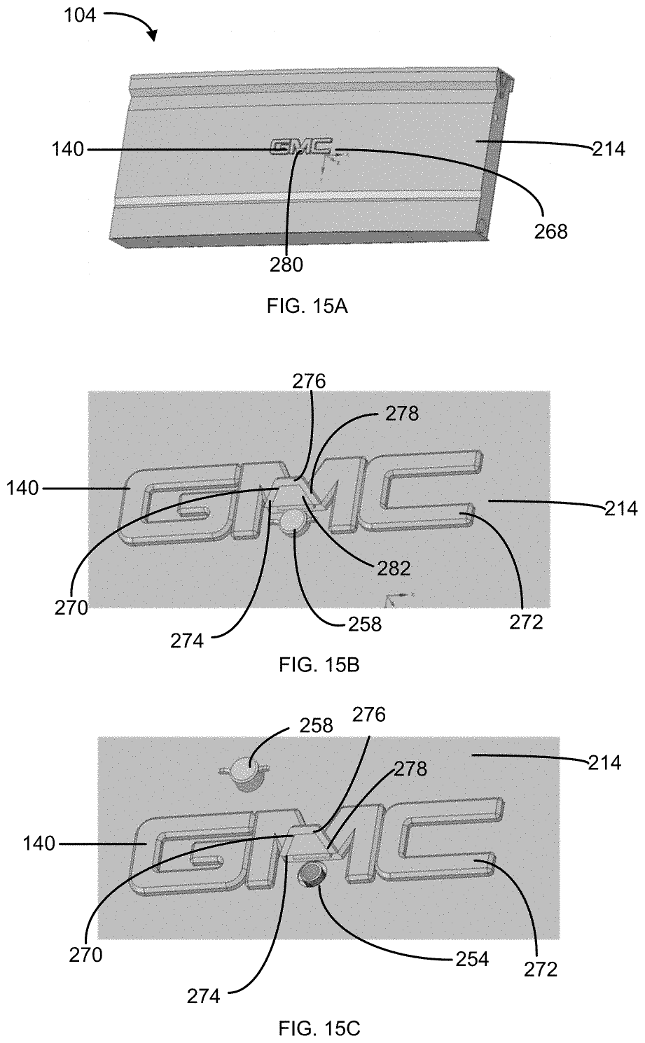

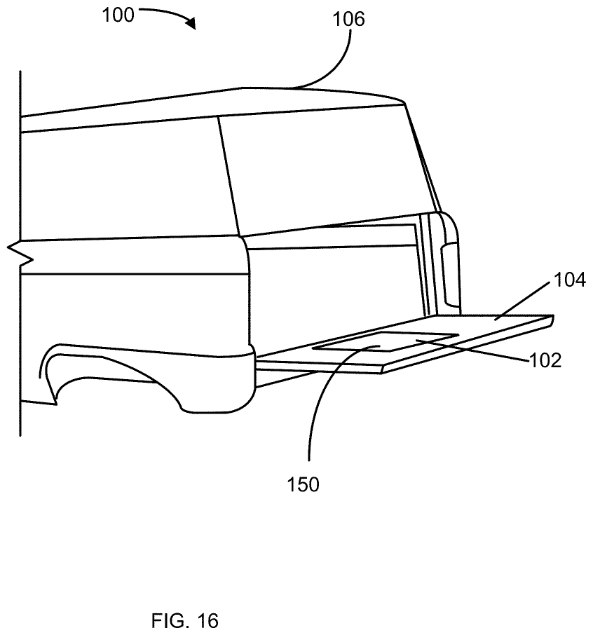

In the vehicle tailgate BBQ grill system 100, a vehicle tailgate BBQ grill 102 is incorporated into a tailgate 104 of a vehicle, as shown in FIGS. 1-19. The vehicle 106 may be a truck or any other vehicle with a suitable tailgate as shown in the figures. The vehicle bed 114 may have a front end 108. The front end may be directly behind a cab section 110 of the vehicle 106. The front end 108 may be connected to a first sidewall 116 having a first top portion 118 and an opposing second sidewall 120 having a second top portion 122. The vehicle bed 114 is configured to provide a cargo space for transporting goods. The tailgate 104 opposes the front end 108. The tailgate 104 has a generally open position 124, as shown in FIG. 1, where the tailgate 104 is generally horizontal or flush with the vehicle bed 114 and a generally closed position 126, as shown in FIG. 2, wherein the tailgate 104 is perpendicular to the vehicle bed 114. The tailgate 104 may have a first locking mechanism 128 for locking the tailgate 104 in the generally closed position. The first locking mechanism may include, for example, a spring-loaded bolt, a security latch and keeper, trailer gate spring latch, a cotter pin, a security clasp, or any other locking mechanism for locking the tailgate 104 in a closed position 126. The tailgate 104 may have a second locking mechanism 130 configured to lock the tailgate 104 in the generally closed position. The second locking mechanism may include, for example, a spring-loaded bolt, a security latch and keeper, trailer gate spring latch, a cotter pin, a security clasp, or any other locking mechanism for locking the tailgate 104 in a generally closed transporting position 126. The vehicle bed 114 may have a first cable or a pair of hinged arms, wherein a first end of the first cable is coupled to a first side of the tailgate 104 and a second opposing end of the cable is coupled to the first sidewall 116 of the vehicle bed 114. The cable aids in supporting the tailgate 104 when the tailgate 104 is in the generally open position. The vehicle bed 114 may have a second cable wherein a first end of the second cable couples to a second side of the tailgate 104 and an opposing second end of the second cable attaches to the second sidewall of the vehicle bed 114, allowing the tailgate 104 to support more weight when the tailgate 104 is in the open position. The tailgate 104 has proximal end 132 and an opposing distal end 134. The proximal end 132 is rotatably connected to the vehicle bed 114 allowing the tailgate 104 to rotate from the closed position 126 to the open position 124. The distal end 134 may be the same height as the first sidewall 116 and the second sidewall 120. A front portion 136 of the tailgate 104 opposes a back portion 138 of the tailgate 104. A decal 140, such as the manufacturers decal 140, may be located on the back portion of the tailgate 104, as shown in FIG. 2 and FIGS. 15A-15C. The back portion of the tailgate 104 may have a handle 142 to release the tailgate 104 to be moved from the closed position 126 to the open position 124.

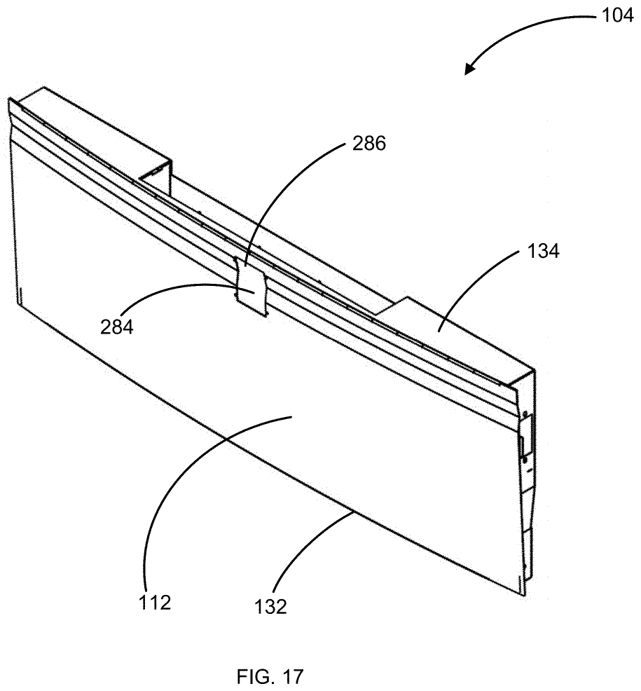

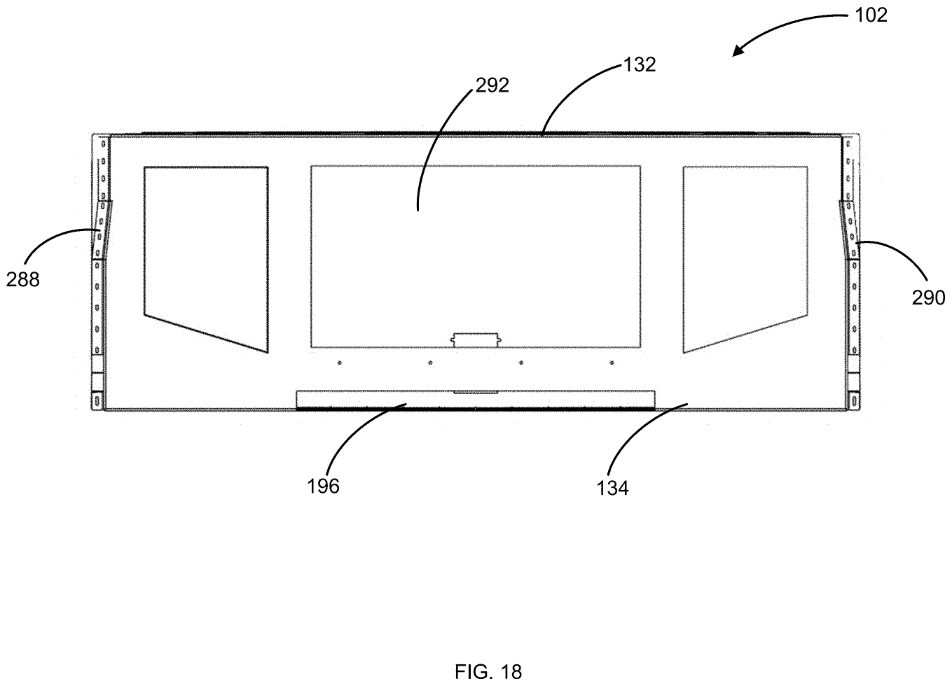

The tailgate 104 may have a lift assist 286 or power lift assist 286 to aid in opening and closing the tailgate 104 or regulating the speed at which the tailgate 104 opens as shown in FIGS. 17 and 18. The controlled descent reduces wear and prevents damage to the tailgate hinges or attachment points. One or more torsion bars may be attached or operably connect to the first sidewall 116 of the vehicle bed, the second sidewall 120 of the vehicle bed, or the bottom of the vehicle bed. The one or more torsion bars may bear the weight of the tailgate 104 making the tailgate 104 easier to open. Stress on the one or more torsion bars is released when the tailgate 104 is moved to the closed position 126, making the tailgate 104 easier to close. The lift assist may be adjusted to handle lighter or heavier gates. The lift assist may be a power lift assist. The power lift assist may have a secure lift assist control module near a lift assist actuator that opens or closes the tailgate 104. The power lift assist may have an open or close button on the tailgate 104, the button or switch may be on the tailgate 104, on a remote, or located in the vehicle 106.

In some aspects of the lift assist, the first locking mechanism 128 and the second locking mechanism 130 are located on the interior of the vehicle bed 114 for the tailgate 104 to attach to. When the tailgate moves to a tailgate closed position 126, mounted latches, 288 and 290 on the tailgate 104 line up with posts on the first sidewall 116 and the second sidewall 120 to intersect and latch down due to a spring-loaded mechanism in the latches 288, 290, thereby creating the first locking mechanism 128 and the second locking mechanism 130 or creating additional locking mechanisms. To release the latch 288 or 290 or plurality of latches, the latches 288, 290 can be physically pulled away from the tailgate 104. A cable runs from each latch, a first latch 288 operably connected to the first side wall 116 and the second latch 290 operably connected the second sidewall 120 to the center of the back portion of the tailgate 140 and attaches to a spring-loaded handle 284. The handle 284 may be visible from the outside of the tailgate 104. The handle 284 may also function as the tailgate handle 142. When the handle 284 is pulled the cable or plurality of cables tighten and pulls each latch 288, 290 to release the tailgate 104 from the first sidewall 116 and the second sidewall 120, thereby allowing the tailgate to be opened. The latches 288, 290, may have to be pulled at an angle that is nearly 180 degrees in the opposite direction. The cables may be designed to follow a specific round to prevent wear on the cable while still being able to pull the latches 288, 290 at a near 180-degree angle.

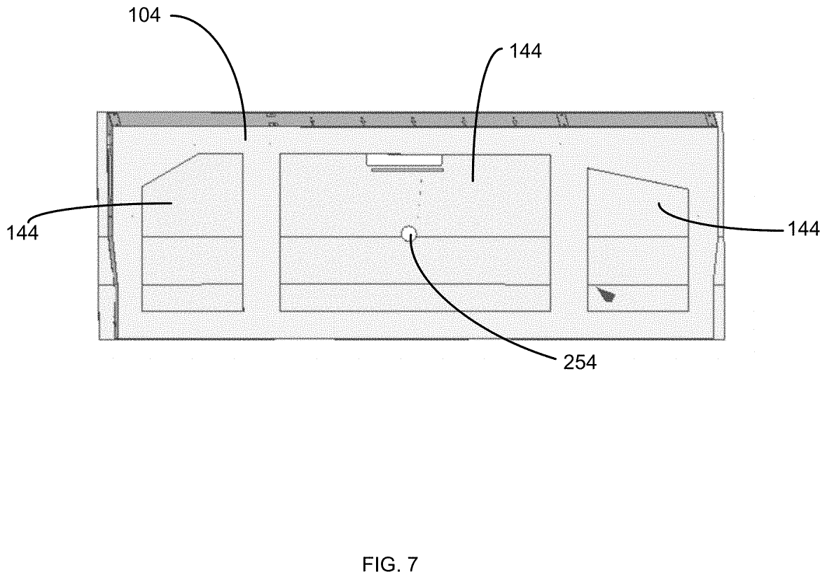

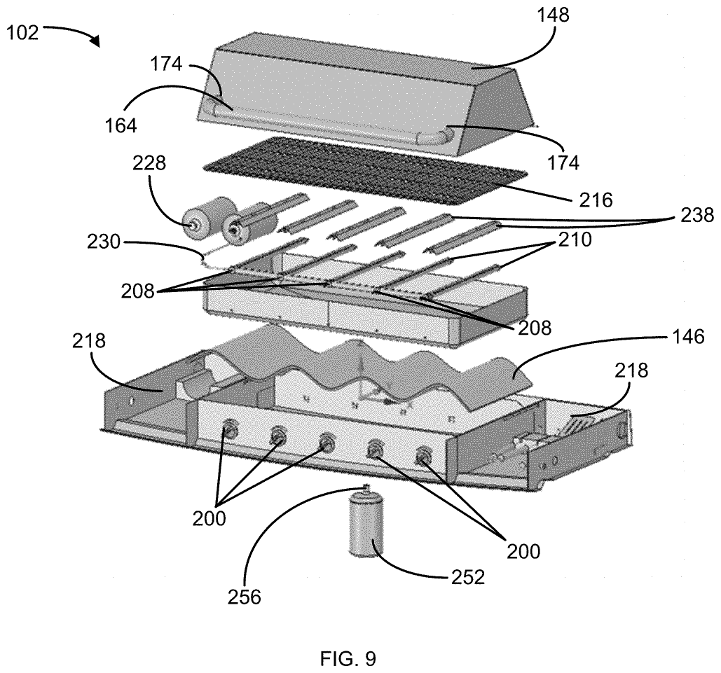

A vehicle tailgate BBQ grill 102 may be integrated into the front portion of the tailgate 104, as shown in FIGS. 1, 3-6, 8-11, 16, 17 and 19. An integrated vehicle tailgate BBQ grill 102 provides a convenient alternative to traveling with a separate grill when camping, picnicking, hiking, hunting, tailgating, or participating in other like activities. The vehicle tailgate BBQ grill 102 may be permanently integrated into the tailgate 104 or the vehicle tailgate BBQ grill 102 may be removeable, as shown in FIG. 7. The tailgate 104 may have slots 144 for removably securing the vehicle tailgate BBQ grill 102. A vehicle tailgate BBQ grill safety mechanism allows the vehicle tailgate BBQ grill to quickly be released from the tailgate 104 or the safety mechanism may release the tailgate 104 from the vehicle bed 114 in the case of extreme heat or fire. A heat shield lining 146, as shown in FIG. 9, by way of example, directs heat away from the vehicle 106. The vehicle tailgate BBQ grill 102 can accommodate various combustion systems and may be a gas grill, pellet grill, or a charcoal grill. The vehicle tailgate BBQ grill 102 has detachable parts that facilitate easier cleaning as shown in FIG. 9. Vehicle tailgate BBQ grill 102 cooking units 158 may have different grill surface spaces. One may be a 24″ wide grill surface or cooking unit 158, while another may span the entire length of the tailgate for the extreme grillers with drawers for storage compartments.

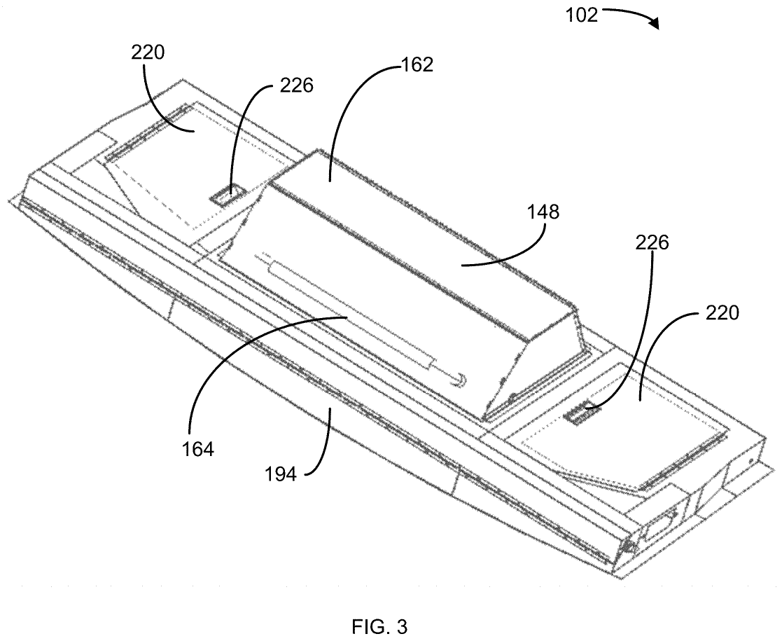

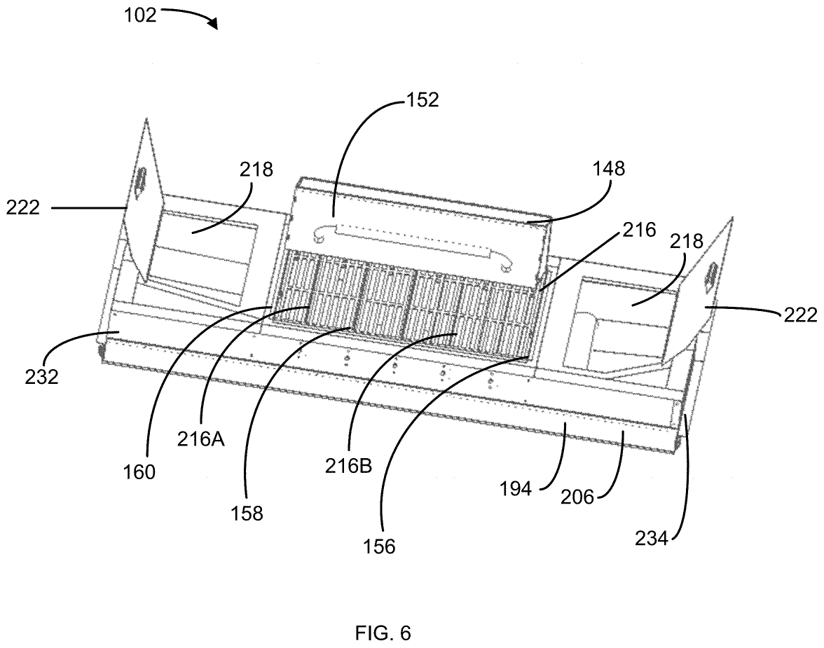

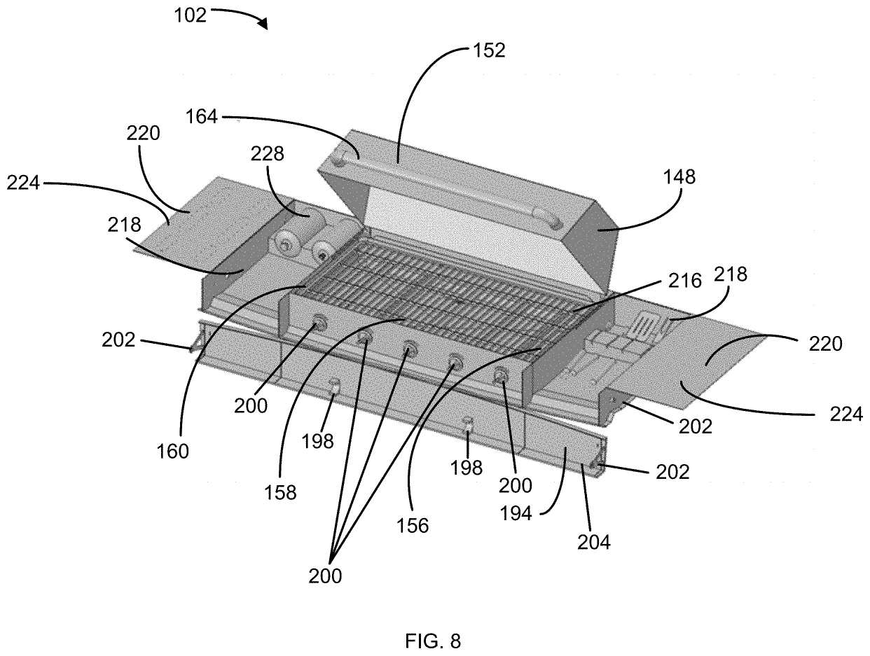

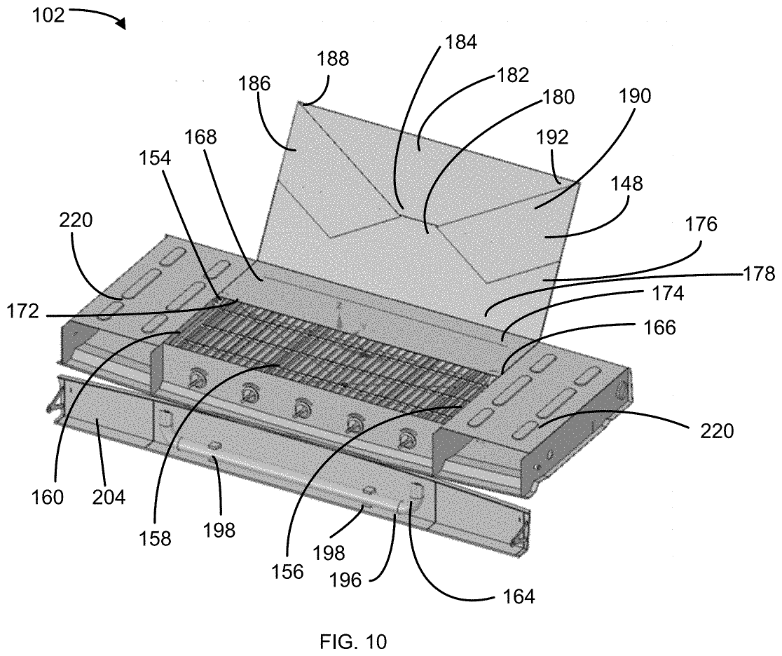

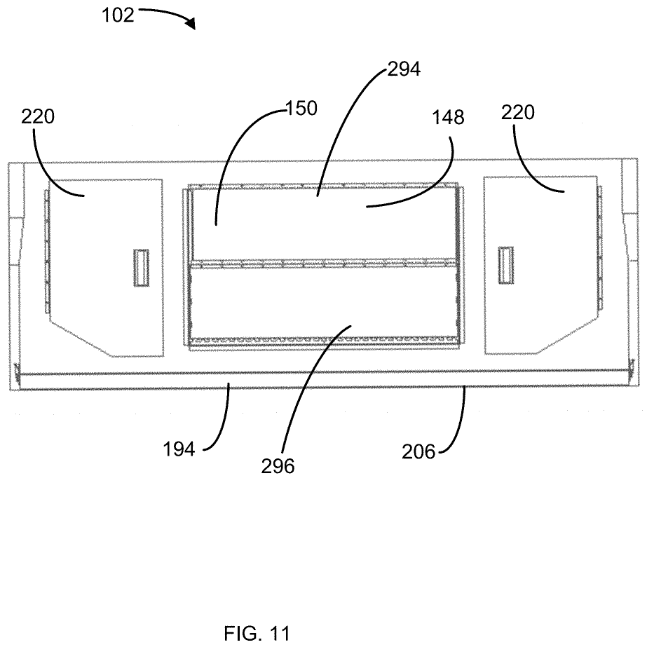

The vehicle tailgate BBQ grill 102 includes, for example, a grill cover 148 which may be placed in an open position 152 to reveal a cooking unit 158 as shown in FIGS. 6 and 8. When the cooking unit 158 is not in use, the grill cover 148 may be placed in a closed position 150, concealing the cooking unit 158 from view and allowing the grate grill to function as a normal tailgate 104 for the vehicle 106, as shown in FIG. 11. The vehicle tailgate BBQ grill 102 may substantially match the dimensions of the tailgate 104, thereby maintaining full use of the cargo area of the vehicle 106 when traveling. In some aspects of the present disclosure, the vehicle tailgate BBQ grill 102 may have a smaller dimension than the dimensions of the tailgate 104. The grill cover 148 is coupled to the tailgate 104 by a coupling mechanism 154, as shown in FIG. 10. The grill cover 148 may be coupled to the tailgate 104 along a right side 156 of the cooking unit 158 and the along the left side 160 of the cooking unit 158, as shown in FIGS. 6 and 8. The coupling mechanism 154 may be an Oldham coupler, contacting toothed wheels or any other coupling mechanism allowing the grill cover 148 to move from the proximal end of the tailgate 132 towards the distal end of the tailgate 134. The grill cover 148 may also be rotatably attached to the tailgate 104 body. The hinge may include a continuous hinge or individually spaced connection points along the length of the grill cover 148. The grill cover 148 may have a folded closed position 162, as shown in FIGS. 3-5, which covers the cooking unit 158 when the cooking unit 158 is in use. The grill cover 148 may have a grill handle 164 that is configured to move the grill from the folded closed position 162 to the open position 152 while the cooking unit 158 is in use. The grill handle 164 may have various designs that facilitate opening and closing the grill cover 148.

When the cooking unit 158 is not in use, the grill cover 148 can be moved to the closed position 150. The grill cover 148 can be rolled forward to a middle portion of the cooking unit 166, as shown by FIG. 10. The grill cover 148 may include a plurality of parts. A first part 168 may have a proximal end 172 coupled to the right side of the cooking unit 158 and the left side of the cooking unit 158 by a coupling mechanism 154 that allows the grill cover 148 to move from the proximal end of the tailgate 132 towards the distal end 134. The first part 168 may fold backward and lay on top of the cooking unit 158. The first part 168 may have a plurality of locking mechanisms or placement slots to connect the first part 168 to the fourth part 186 and fifth part 190 of the grill. A second part 176 of the grill cover 148 may have a proximal end 178 connected to a distal end of the first part 170. The connection may be a hinge connection. The second part 176 may have a plurality of locking mechanisms or placement slots to connect the first part 168 to the fourth part 186 and fifth part 190 of the cooking unit 158. A third part 182 has a proximal end 184 connected to the distal end 134 of the second part. The second part 176 and the third part 182 may be configured to rotate until the third part 182 is in a straight line with the second part 176. The connection may be a hinged connection. The third part 182 may have a plurality of locking mechanisms or slots to connect the third part 182 to the fourth part 186 and fifth part 190 of the cooking unit 158. The third part 182 may be connected to the fourth part 186 and fifth part 190 by a hinge connection, allowing the fourth part 186 and the fifth part 190 to rotate relative to the third part 182. The third part 182 may have one or more connection points 174 for connecting the grill handle 164 to the grill cover 148, such as a first connection point for connecting with a first end of the grill handle 164 and a second connection point for connecting with a second end of the grill handle 164 opposing the first end of the grill handle 164. A fourth part 186 is connected to a first side of the third part 188 and is configured to fold inward to lay on top of a surface of the second part 176 and the third part 182. The connection may be a hinged connection. The fourth part 186 may have ridges or a locking mechanism for coupling to the first part 176, the second part, or the third part 182. A fifth part 190 is connected to a second side of the third part, the second side 192 opposing the first side 188. The fifth part 190 is configured to fold inward and lay on top of the surface of the second part 176 and the third part 182. The connection may be hinged. The fifth part 190 may have ridges or a locking mechanism for coupling to the first part 176, the second part, or the third part 192. After the fourth part 186 and the fifth part 190 are folded inward, the second part 176 and third part 182 rotate downward until the second part 176 and third part 182 are flush with the front end of the tailgate 104 and the grill cover 148 is in the horizontal closed position. The fourth part 186 and fifth part 190 may have a bottom part configured to be perpendicular to the grill when the grill cover 148 is in the folded closed position 162. The fourth part 186 and fifth part 190 may have at least indent configured to fit a securing mechanism for securing the grill and grease tray 240 to the tailgate 104.

In some aspects, the grill cover 148 may move from the open position 152 to the closed position 150 by a different method. The proximal end of the first part 172 is connected to a proximal end of the cooking unit 294 opposing a distal end of the cooking unit 296. The distal end of the first part 170 is connected to the proximal end of the second part 178. The connection allows the second part of the grill cover 176 to move relative to the first part of the grill cover 182. The distal end of the second part of the grill cover 180 is connected to the proximal end of the third part of the grill cover 184 by a permanent or removable connection. The connection allows the third part of the grill cover 182 to move relative to the second part of the grill cover 176. A side of the fourth part of the grill cover 186 is connected to a first side of the third part of the grill cover 188. The connection allows the fourth part of the grill cover 186 to move relative to the third part of the grill cover 182. A side of the fifth part of the grill cover 190 is connected to the opposing second side of the third part of the grill cover 192. The connection allows the fifth part of the grill cover 190 to move relative to the third part of the grill cover 182. The connections may be permanent connections or removable connections that may including hinges, welding, slots, hooks, or any other connections.

To move the grill cover 148 from the open position 152 to the closed position 150. The fourth part of the grill cover 186 moves inwards towards the third part of the grill cover 182 and the fifth part of the grill 190 moves inward towards the third part of the grill cover 182. The first part of the grill cover 168 rotates clockwise or counterclockwise towards the second part of the grill cover 176 until it adjacent to a top portion of the second part of the grill cover or a bottom portion of the second part of the grill cover. Then the grill cover 148 is laid flush with the tailgate 104.

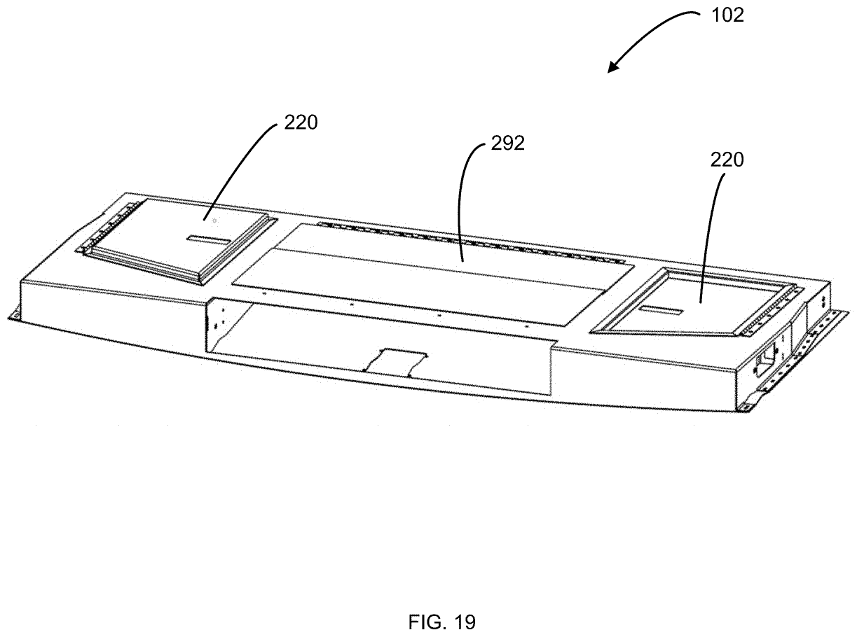

The grill cover 148 may be secured down with spring latches hidden inside the storage compartments. The grill cover may sit flush when closed and have a built-in dust cover 292, as shown in FIGS. 18 and 19. that overlaps on the surface of the tailgate protecting against debris entering the cooking unit. The dust cover 292 may also be placed over the grill cover 148. The dust cover 292 may be sized as the same dimensions as the grill cover 148 or the dust cover 292 may expand beyond the dimensions of the grill cover 148. The dust cover 292 prevents water, dust, and debris from entering the cooking unit 158. The dust cover 292 may be a single cover or may have a plurality of parts separated by a hinge allowing the dust cover 292 to bend or fold while not in use. In some aspects, the dust cover 292 may cover a portion of the front of the tailgate and the top of the tailgate, thereby covering the control knows when they are not in use. The dust cover 292 may have a dust cover 292 attachment on the first side, second side, or top of the dust cover 292 to secure the dust cover 292 to the tailgate 104. The dust cover 292 may secure the grill cover when in a closed position, therefore the grill cover may not need to be securely attached to the tailgate or the cooking unit. The dust cover 292 may be secured down with spring latches hidden inside the storage compartments.

The top wall of the tailgate 194 may be rotatably connected to the back end of the tailgate 104 allowing the top wall of the tailgate 194 to swing towards the back end of the tailgate 104 revealing a storage compartment 196 for storing the grill handle 164 once the grill handle 164 is removed from the grill cover 148. In some aspects, the top wall of the tailgate 194 may have front portion 212 and a back portion 214, the front portion 212 rotatably connected to the back portion 214, the front portion 212 configured to rotate around the hinge towards the back portion 214 revealing the storage compartment 196 for storing the grill handle 164, as shown in FIG. 3.

The top wall of the tailgate 194 may have at least one storing mechanism 198 for holding the handle, such as clips, yokes, or any other mechanism capable of holding the grill handle 164. The storing mechanism 198 may be mechanically or magnetically fastened to the top wall of the tailgate 194. The storing mechanism 198 may include a round base shaped to generally conform to the shape of the handle. The storing mechanism 198 may be flexible and it may include an opening wide enough to accommodate the width of the grill handle 164 when the storing mechanism 198 flexes but narrow enough to generally retain the grill handle 164 to removably and securely retain the grill handle 164. The storing mechanism 198 may also absorb vibration to prevent damage to the assembly during use and transportation. The storing mechanism 198 may be formed using steel or another suitable material capable of withstanding temperatures associated with a vehicle tailgate BBQ grill 102.

The top wall of the tailgate 194 may also cover the control knobs 200 for safety, thereby preventing the control knobs 200 from be turned or bumped during transport or while a user is not standing next to the cooking unit 158 while the cooking unit 158 is in use, as best shown in FIGS. 9 and 10. The top wall of the tailgate 194 contains at least one locking mechanism 202 for securing the top wall of the tailgate 194 in the closed position 206, covering the control knobs 200 and grill handle 164. The open position of the top wall of the tailgate 194 allows the control knobs 200 to be visible as shown in FIGS. 9 and 10. The locking mechanism 202 may be a latch, a cotter pin, a security hasp, or any other suitable (e.g., mechanical) locking mechanism can lock the top wall of the tailgate 194 in a closed position. The locking mechanisms may be located at each end of the tailgate for securing the top wall of the tailgate 194 to the tailgate 104. The top of the tailgate may have one or more securing mechanisms to secure the dust cover 292 to the top of the tailgate to prevent the dust cover 292 from opening during transport or while the grill is not in use. In some aspects of the present disclosure, the dust cover 292 may replace the portion of the top of the tailgate that covers the control knobs. One or more pieces of trim may be placed on or around the top wall of the tailgate 194 adjacent to the dust cover 292 to prevent the dust cover 292 from being bumped or while the dust cover 292 is closed.

The control knobs 200 are accessible when the tailgate 104 is in the open position 124 and the closed position 126. The control knobs 200 face upward vertically when the tailgate 104 is in the closed position 126 and outward horizontally when the tailgate 104 is in the open position 124. An igniter 208 may also be positioned in the cooking unit 158 to ignite the flame elements 210 of the vehicle tailgate BBQ grill 102, as shown in FIG. 9. The grill cover 148 may act as a barrier to shield the control knobs 200, igniter 208, or other control elements or display devices from the cooking unit 158, such as from a grill grate 216 upon which the food may be cooked. The grill cover 148 may protect the control elements from heat, flame, or hot splatter.

The grate grill may have additional storage compartments 218 or storage cabinets 218, as shown in FIGS. 6, 8, and 19. The storage compartments 218 may be to the right of the cooking unit 158 and may be to the left of the cooking unit 158 or may be storage drawers that slide out of the top of the tailgate 104 when the tailgate is in the open position. The drawers may be located on one or more sides of the dust cover 292 or control knobs. The storage compartments 218 or storage drawers may be configured to store food, tools cleaning equipment, a spice or seasoning rack, speaker system, television, or other suitable or like items. The storage compartments 218 or drawers may be configured to be a cutting board or be insulated or refrigerated to keep items cool. The storage compartments 218 or storage drawers may be removable, or the doors of the storage compartments 220 may be removable. The doors 220 are rotatably coupled to the tailgate 104. The doors of the storage unit 220 may open and be locked in a perpendicular position to the tailgate 222. The angle of the open door may be greater than 90 degrees or fold 180 degrees. The doors of the storage compartment 222 may provide additional table space extending beyond the tailgate 104 when open in a generally horizonal open position 224, as shown in FIG. 8. The doors 220 may have handles 226 to allow a user of the vehicle tailgate BBQ grill 102 to open the doors to the storage compartment 220. Each storage compartment 218 can come with a lock or non-locking latch mechanism. The storage compartment may be countersunk into the tailgate, as shown in FIG. 19, allowing objects stored in the bed of the vehicle to easily be removed from the bed of the vehicle without hitting the storage compartment and potential damaging the storage compartment.

One of the storage compartments 218 or storage drawers may be configured to store a fuel source 228, such as a propane tank or other suitable cooking-fuel container, charcoal, or pellets for fueling flame of the vehicle tailgate BBQ grill 102, as shown in FIG. 8. A fuel valve assembly 230 may be positioned in the tailgate 104, for example in one of the storage compartments 218. A cable duct may house the fuel valve assemble 230. The fuel valve 230 assembly may provide a connection point for the fuel source 228. The fuel source 228 may also be integrated with the vehicle 106 and can be connected to the fuel valve 230 assembly through a plumping, such as a piped plumbing connection. The door of the storage container 226 or a separate lid may be positioned over the fuel valve assembly 230 to protect it from the environment or from other wear or damage. A ventilation tube may be located next to one of the storage containers 226. The cable duct may also be located next to at least one of the storage compartments 218.

In some aspects, the fuel source 228 may be an electric fuel source powered by the vehicle. The vehicle tailgate BBQ grill 102 may have one or more electrical cords for powering the vehicle tailgate BBQ grill 102 and heating the cooking unit 158. The electrical cords may be attached to one or more flame elements 210 through the storage compartments 218. The electrical cords may be connected to an electrical outlet or power source located in the vehicle bed 114. The cooking unit may have a button, switch or another on/off mechanism for powering the cooking unit 158 through the electric fuel source.

A grate 216 is located beneath the grill cover 148 for cooking food while the vehicle tailgate BBQ grill 102 is in use. A plurality of grates 216 may be used, the plurality of grates 216 configured to fit in the vehicle tailgate BBQ grill 102 together. In one aspect of the vehicle tailgate BBQ grill system 100, the system is configured with two grates 216A and 216B, one grate 216A is positioned closer to the first end of the tailgate 232 and a second grate 216B closer to an opposing second end of the tailgate 234. The two grates 216A and 216B may be positioned, so that the first grate 216A is closer to the proximal end of the tailgate 132 and the second grate 216B is closer to the distal end of the tailgate 134. The grate 216 is positioned and secured to the vehicle tailgate BBQ grill 102 to allow retention in both the open position 124, as well as the closed position 126 for traveling. A securement (e.g., mechanical) 236 may be used to ensure the grate will not dislodge when the vehicle tailgate 104 is in the closed position 126 during non-use or when traveling. There may be a plurality of securements 236 along the side of the opening to ensure proper securement of the grate 216. Other securements 236 may be operably incorporated in the grate, can include, for example, fasteners, clasps, and appropriate cut-outs for fitting the grate 216 to the vehicle tailgate BBQ grill 102. Beneath the grate 216 may be one or more heat spreaders 238 or heat shields, or heat directors, as shown by way of example in FIG. 9. Beneath the one or more heat spreaders 238 may be one or more burners or one or more flame elements 210. In some aspects, the one or more flame elements 210, the one or more heat spreaders, and grate 216 may each be attached to a grease tray 240 that is removably mounted in the tailgate 104. The grease tray 240 may also support the igniter 208, control knobs 200, a gas manifold or fuel valve assembly 230 for distributing gas to the flame elements 210 or other suitable components. The grease tray 240 may also support a heat shield 146.

The one or more flame elements 210 provide flames using fuel from the fuel source 228 via the valve assembly 230. The flames may be ignited using the igniter 208 and regulated using the control elements. The flames heat the one or more heat spreader(s) 238, which in turn radiate heat to the grill grate 216 and any food thereon. An igniter 208 may be positioned next to each flame element to ignite each flame element for use.

The heat spreaders 238 may have one or more main plates 240. The main plates 240 may be orientated at an angle relative to level grate 216. The angle may be suitable to fit inside the vehicle tailgate BBQ grill 102 while providing enough heat along the heat spreaders 238 and allow debris or grease to drip away from the heat spreaders 238 down into the grease tray 240. One or more heat spreaders 238 may have holes or perforations to allow flames or additional heat to pass through the heat spreaders 238. The heat spreaders 238 may be removeable. The removable and replaceable nature of the heat spreaders 238 provides for ease in cleaning the vehicle tailgate BBQ grill 102 and replacing the heat spreaders 238. The heat shield 146 may be below the heat spreaders 238.

The heat shield 146 may include, for example, a coating, jacket, blanket, or other layer of insulation. The heat shield 146 may be positioned around the sides and bottom or other outer surfaces of the grease tray 240. The heat shield 146 may reflect heat into the grill grate 216 or otherwise prevent or resist heat from spreading out of the cooking unit 158 or from spreading to the storage compartments 218. The heat shield 146 may be positioned on an underside or bottom of the grease tray 240 to prevent or resist damage to the tailgate 104, as shown in FIG. 9, such as damage to exterior paint on the tailgate 104 or prevent injury when a person walking by touches the tailgate 104. The heat shield 146 may be below the heat spreaders 238 or in place of the heat spreader's 238 main plates 240. Heat blankets may direct heat off of surfaces that do not need to be heated. The heat blanket may be spread along the interior of the back of the opened tailgate when the grill is in use, keeping the heat off of the back of the tailgate for safety. The heat blanket may include silicone coated silica ceramic fabric, a ceramic needled fiber mat core, a stainless steel knitted wire mesh, polytetrafluoroethylene laminate, fiberglass needle mat, silicone impregnated fiberglass cloth, vermiculite coated fiberglass aluminized mat, silica fabric, fiberglass fabrics, insulation mats, aluminum fabric, titanium carbon fabric, silver or gold fabric or other suitable materials with thermal resistance properties optimal for preventing or resisting heat transfer.

The heat shield 146 may include fiberglass, a fiberglass interior surrounded by outer layers of metal foil, multi-walled ceramic materials, vacuum vessels, foam, wood, or other suitable materials with thermal resistance properties optimal for preventing or resisting heat transfer. The frame of the tailgate 104 may include a heat shield 146. The heat shield or heat blanket may include reflective material that reflects the heat back towards the grate to increase the cooking heat. The heat shield 146 may be angled. The angle may be suitable to fit inside the vehicle tailgate BBQ grill 102 while allowing debris or grease to drip away from the heat shield 146 down into the grease tray 240.

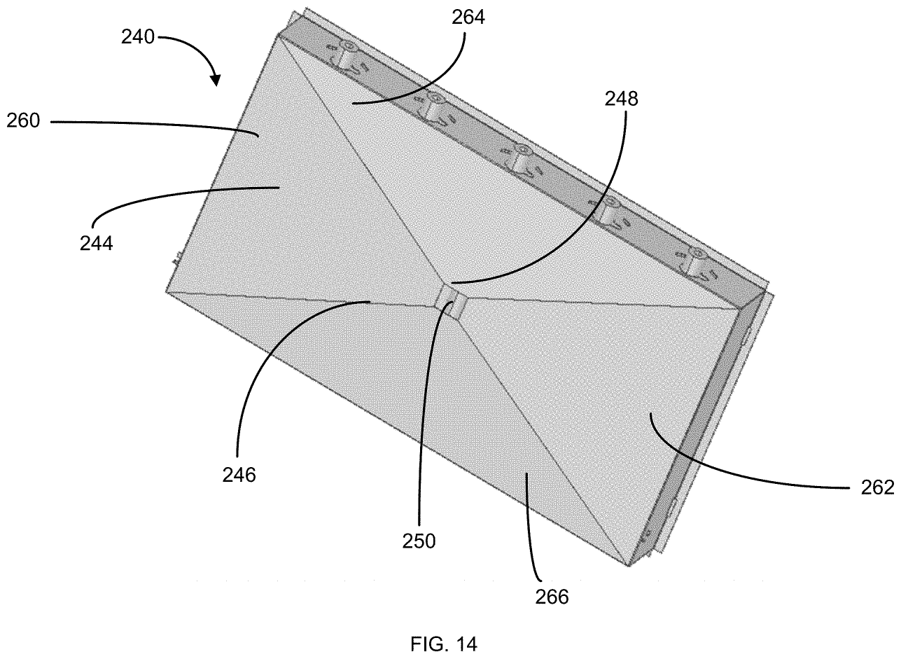

The grease tray 240, as shown in FIGS. 9 and 12-14, may be positioned in the tailgate 104 to collect grease and other debris. The grease tray may be removable from the cooking unit where the grease tray may be cleaned and then placed back into the cooking unit. The grease trays may slide out or be lifted out from the cooking unit. Disposable grease pads may be used with the grease tray or instead of the grease tray. The disposable grease pads may be removed after the user is finished using the vehicle tailgating BBQ grill and disposed of New grease pads may replace the previous ones. The grease pads may also be reusable. The grease tray 240 may be angled 246 to funnel the grease and other debris out of the tailgate 104 when the tailgate 104 is in the open position 124 or in the closed position. Grease and debris drain from the grate 216 to the grease tray 240, the bottom of the grease tray 244 downwardly sloped 246 to the middle of the bottom portion 248 of the grease tray 240, as shown in FIG. 14. The grease travels downward to the middle 248 and is funneled out through a drainage hole 250 in the center of the grease tray 240. The drainage hole 240 may have threads to couple with a grease container 252, as shown in FIG. 15C. The grease and debris are funneled into the grease container 252 as shown in FIG. 9 which may be coupled to the grease tray 240 or the tailgate 104. In at least one configuration, the grease container is perpendicular to the tailgate 104 when the tailgate 104 is in the open position 124, allowing gravity to move the grease and debris into the grease container 252. The grease container 252 may be a canister or a grease bucket. Disposable one-time grease pads or reusable grease pads may be used as the grease container 252 to catch grease and maybe placed underneath the hole. The back of the tailgate 214 may have a tailgate hole 254, as shown in FIGS. 7 and 15C, configured to allow the grease to drain from the grease tray 240 out of the tailgate 104. The grease container may couple to the hole in the tailgate 104 to collect the grease and debris. A top of the grease container 256 may pass through the tailgate hole 254 to couple with the grease tray 240 to collect grease and debris. A grease cap 258 may cover the drainage hole 250 or the tailgate hole 254. The grease cap 258 may have threads to couple with the drainage hole 250 or tailgate hole 254. The grease cap 258 may couple to the tailgate hole 254 or to the drainage hole 250. The grease cap 258 can be flush with the surface of the back portion of the tailgate 214. A user may unscrew the grease cap 258 or pop the grease cap 258 or use another suitable method to remove the grease cap 258 from the drainage hole 250 or tailgate hole 254.

In some aspects, the drainage hole 250 may not be located in the middle of the grease tray 248, the drainage hole 250 may be located closer to a first side of the grease tray 260 or an opposing second side of the grease tray 262. The drainage hole 250 may be located closer to the top of the grease tray 264 or the bottom of the grease tray 266. The location of the drainage hole 250 may be configured to line up with a decal 140 of the vehicle's manufacturer located on the tailgate 104, as shown in FIGS. 15A-15C. Having the grease tray 240 drain while the tailgate 104 that when in the open position 124 allows a user of the vehicle tailgate BBQ grill system 100 to easily clean the grill. By draining the grease while the tailgate 104 is in the open position 124, the grease does not move out of the grease tray 240 when the tailgate 104 is moved from the horizonal position to the closed position 126. Furthermore, gravity does not move all the grease to the bottom of the grease tray 244 when the tailgate 104 is in the closed position 126. To clean the vehicle tailgate BBQ grill system 100, a user only needs to pour liquid and/or a degreaser over the grill, the liquid moving through the grate 216 and moving the grease and debris through the drainage hole 250, providing an efficient cleaning method. The grease tray 240 may be removed for cleaning.

The decal 140 may be located on the back of the tailgate 214, as shown in FIGS. 2 and 15A-15C. The decal 140 may be located, for example, in the center of the back side of the tailgate 248. A first portion of the decal 270 or the entire decal may be moveable. In one aspect, the proximal end, opposing a distal end 276 of the first portion 270 is rotatably connected to the second portion of the decal 272. In one aspect, the second portion 272 is unmovable. In other aspects the entire decal 140 may be moveable. The first portion 270 may be lifted up, swinging around the hinge in an open position 278 to reveal the tailgate hole 254 for draining grease. The closed position 280 of the first portion hiding the tailgate hole 254. The first portion 270 of the manufacturing decal may cover the grease cap 258. An interior surface 282 of the first portion of the manufacture decal may be indented to fit over the cap while the cap is covering the drainage hole 250 and tailgate hole 254, hiding the grease cap 258 from view when the first portion is in the closed position 280.

The disclosure is not to be limited to the particular aspects described herein. In particular, the disclosure contemplates numerous variations in vehicle tailgate BBQ grills. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of aspects, processes, or methods of the disclosure. It is understood that any other modifications, substitutions, and/or additions can be made, which are within the intended spirit and scope of the disclosure.

What is claimed is:

1. A vehicle tailgate BBQ grill system, comprising:
a tailgate configured to hold the vehicle tailgate BBQ grill system, wherein the tailgate is configured to attach to a vehicle bed and comprises a front end opposing a back end and a first end opposing a second end;
a grease tray integrated into the tailgate configured to collect grease;
a grate, wherein the grate is supported by the grease tray; the grate is configured to drop grease and debris into the grease tray;
a plurality of heat spreaders;
at least one flame element;
at least one storage compartment, the storage compartment configured to hold a fuel container, wherein the fuel container is operably connected to the plurality of flame elements;
at least one control knob operably connected to the fuel container and the at least one flame element; and
a vehicle tailgate BBQ grill cover disposed on the front end of the tailgate, wherein the vehicle tailgate BBQ grill cover has an open position configured to reveal the grate, and wherein the vehicle tailgate BBQ grill cover has a first part rotatably connected to the tailgate.

2. The vehicle tailgate BBQ grill system of claim 1, wherein the vehicle tailgate BBQ grill cover has a closed position wherein a back surface of the vehicle tailgate BBQ grill cover is flush with the tailgate.

3. The vehicle tailgate BBQ grill system of claim 1, wherein the vehicle tailgate BBQ grill cover comprises a plurality of parts and at least two of the parts are configured to fold inward.

4. The vehicle tailgate BBQ grill system of claim 1, wherein the vehicle tailgate BBQ grill cover further comprises a dust cover.

5. The vehicle tailgate BBQ grill system of claim 1, wherein the at least one storage compartment is countersunk from a top surface of the front end of the tailgate.

6. The vehicle tailgate BBQ grill system of claim 1, further comprising:
a lift assist configured to aid in opening and closing the tailgate, wherein the power lift assist comprises a first latch on the first end of the tailgate and a second latch on the second end of the tailgate and a handle on the back end of the tailgate, wherein the handle is configured to release the latches when pulled away from the back end of the tailgate.

7. The vehicle tailgate BBQ grill system of claim 1, wherein the grease tray and grate are removable.

8. A vehicle tailgate BBQ grill system, comprising:
a tailgate configured to hold the vehicle tailgate BBQ grill system, wherein the tailgate has a front end opposing a back end and a top portion opposing a bottom portion, wherein the bottom portion is configured to be attached to a vehicle;
a cooking unit disposed within the front end of the tailgate configured to heat a grate, the cooking unit comprising:
a grease tray operably integrated into the tailgate;
a grate operably supported by the grease tray, wherein the grate is configured to drop grease and debris into the grease tray;
a vehicle tailgate BBQ grill cover having a closed position configured to hide the grate and an open position configured to reveal the grate, wherein a first part of the vehicle tailgate BBQ grill cover is rotatably connected to the front end of the tailgate;
a heat shield configured to protect the back end of the tailgate from cooking unit;
a first storage compartment on a first side of the grate;
at least one control knob operably connected a fuel source and at least one fuel element, wherein the fuel source powers the at least one flame element, wherein the at least one control knob is covered when the tailgate is in a closed position;
a dust cover configured to prevent debris from entering the cooking unit when the vehicle tailgate BBQ grill cover is in the closed positioned.

9. The vehicle tailgate BBQ grill system of claim 8, wherein the dust cover has a first portion configured to cover the cooking unit and a second portion configured to cover the at least one control knob.

10. The vehicle tailgate BBQ grill system of claim 8, wherein the cooking unit is removeable.

11. The vehicle tailgate BBQ grill system of claim 8, wherein the at least one storage compartment is a drawer and wherein the drawer is configured to open from the top portion of the tailgate.

12. The vehicle tailgate BBQ grill system of claim 8, wherein the heat shield is a heat blanket.

13. The vehicle tailgate BBQ grill system of claim 9, wherein the tailgate further comprises
a lift assist comprising at least a first latch on a first end of the tailgate and second latch on the opposing second end of the tailgate wherein the first latch is operably connected to a first cable and the second the latch is operably connected to a second cable, wherein the first cable and the second cable are operably connected to a handle disposed on the back end of the tailgate and configured to release the tailgate from the vehicle bed when pulled.

14. The vehicle tailgate BBQ grill system of claim 8, wherein the cooking unit has a closed position wherein a back surface of the vehicle tailgate BBQ grill cover is flush with the tailgate and wherein the grill cover has an angled closed position.

15. A vehicle tailgate BBQ grill system, comprising:
a tailgate configured to hold the vehicle tailgate BBQ grill system, wherein the tailgate has a proximal end rotatably connect to a vehicle bed opposing a distal end, a front end opposing a back end, a first side opposing a second side, and an open position wherein the front end of the tailgate is flush with the vehicle bed;
a vehicle tailgate BBQ grill integrated into the front end of the tailgate; the vehicle tailgate BBQ grill, comprising:
a grease tray integrated into the tailgate configured to capture grease and debris;
a grate operably supported by the grease tray and operably configured to drop grease and debris into the grease tray;
a first storage compartment on a first side of the grate, the storage compartment configured to hold a fuel container, wherein the fuel container is operably connected to a plurality of flame elements configured to heat the grate;
a second storage compartment on the second side of the grate, wherein the storage compartment is countersunk from a surface of the front end of the tailgate;
a plurality of control knobs operably connected to the fuel container and the plurality of flame elements;
a grill cover at the proximal end of the tailgate having a closed position configured to hide the grate, wherein the grill cover has an open position configured to reveal the grate; and
a lift assist.

16. The vehicle tailgate BBQ grill system of claim 15, wherein the fuel source is electric.

17. The vehicle tailgate BBQ grill system of claim 15, wherein the grill cover comprises a plurality of parts of the grill, a proximal end of a first part of the plurality of parts of the grill is coupled to the grease tray, a proximal end of a second part of the plurality of parts of the grill cover is coupled to a distal end of the first part opposing the proximal end of the first part, a proximal end of a third part of the plurality of parts of the grill cover is coupled to a distal end of the second part opposing the proximal end of the second part, a fourth part of the plurality of parts of the grill cover is coupled to a first side of the third part and a fifth part of the plurality of parts of the grill cover is coupled to a second side of the third part opposing the first side of the third part.

18. The vehicle tailgate BBQ grill system of claim 17, wherein the proximal end of the third part rotates relative to the second part.

19. The vehicle tailgate BBQ grill system of claim 15, wherein the first storage compartment is a drawer.

20. The vehicle tailgate BBQ grill system of claim 15 wherein the grill cover further comprises a dust cover configured to prevent debris and dust from entering the grate when the grill cover is in the closed position.
